(19) United States
(12) Patent Application Publication
(10) Pub. No.: US 2021/0044478 A1
(43) Pub. Date: Feb. 11, 2021

(54) SYSTEM AND METHOD FOR INITIAL SETUP OF NETWORK DEVICES

(71) Applicant: HEWLETT PACKARD ENTERPRISE DEVELOPMENT LP, Houston, TX (US)

(72) Inventor: SREENATH SESHADRI, Bangalore (IN)

(21) Appl. No.: 16/534,905

(22) Filed: Aug. 7, 2019

(51) Int. Cl. H04L 12/24; H04L 29/12

(52) U.S. Cl. CPC H04L 41/0806; H04L 41/22; H04L 61/6086; H04L 61/6022; H04L 61/2015

(57) ABSTRACT

Systems and methods are provided for a guided workflow for the initial setup of an enterprise switch for users, e.g., enterprise network administrators with little to no experience with enterprise switch configuration. The guided workflow directs a user regarding entry or capture of a media access control (MAC) address associated with the enterprise switch. The MAC address can be converted to an Internet Protocol version 6 (IPv6) link-local address via an online converter or a converter resident on the user device. Initiation of the conversion launches a web-based graphical user interface (GUI) hosted by the enterprise switch and reachable using the converted IPv6 link-local address.

### DESCRIPTION OF RELATED ART

Wireless digital networks are becoming ubiquitous in enterprises, providing secure and cost-effective access to resources. Those networks usually have one or more controllers, each controller supporting a plurality of access points (AP) deployed through the enterprise. Wireless networks operating in accordance with IEEE 802.11 standards are examples of such networks. Wireless network communications devices (also referred to as stations or client devices), such as personal computers and mobile phones transmit data across wireless digital networks vis-à-vis wireless APs, and cellular network APs, for example.

Wireless local area network (WLAN) infrastructure elements or components in a wireless network provide service to WLAN devices. Most any network component requires some form of proper setup before it can be used. Depending on the functionality a particular network device or component provides, the setup can be a simple process or a more complicated one. Small to medium enterprises or businesses, such as flower shops, dentist's offices, and the like are not often supported by network administrators or users with the requisite expertise or resources to use procedures such as Zero-Touch Provisioning (ZTP). Accordingly, such enterprises generally resort to manually setting up network components using an associated web graphical user interface (GUI) hosted on/by the network component itself.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one example of a network configuration in which various embodiment may be implemented.

FIG. 2 is a block diagram of an example computing component or device for performing initial setup of an enterprise switch in accordance with one embodiment.

FIG. 3A illustrates an example network switch initial setup use case scenario in accordance with one embodiment.

FIGS. 3B, 3C, 3D, and 3E illustrate example web-based GUIs and webpages presented to a user in accordance with a guided workflow of one embodiment.

FIG. 3F illustrates an example analytics and information web-page presented to a user post-setup of an enterprise switch in accordance with one embodiment.

FIG. 4 is an example computing component that may be used to implement various features of embodiments described in the present disclosure.

The figures are not exhaustive and do not limit the present disclosure to the precise form disclosed.

### DETAILED DESCRIPTION

Network devices, such as switches used in smaller to medium-sized enterprises, can provide connectivity to credit card readers (e.g., enterprise-grade switches providing a certain level of security), provide customer wireless access, etc. Such switches may be used in a network with other network devices, but the number of other network devices may be limited, e.g., five or less. In these sorts of enterprises, as alluded to above, switches are usually set up manually by a user without extensive networking experience, and manually setting up a switch can be a complicated and involved process.

When a factory-default switch is connected to an existing network, the user or administrator does not know the Internet Protocol (IP) address to which they should direct their web browser. This is because the user/administrator has no way of ascertaining the IP address that the switch has picked up/with which the switch has associated itself. Switches are unlike network devices, such as access points (APs). APs are able to open a default service set identifier (SSID) running a Dynamic Host Configuration Protocol (DHCP) server to allocate a management address to itself/clients joining an open wireless network (and a user device can easily access a well-known IP address of the AP).

In the case of a network switch, to determine an IP address, the user or administrator must either rely on a web-based GUI (accessed via a web browser) to perform the requisite setup operation(s), or use a serial console cable directly connected to the switch. Thus, manually setting up or enabling a switch (which involves discovering the IP address of the switch) using conventional methods can be complicated. For example, conventional IP address discovery process can involve special hardware and procedures, such as connecting a serial console cable to the switch (to look at the switch's command line interface (CLI)). Alternatively, conventional IP address discovery may require the user to look at Dynamic Host Configuration Protocol (DHCP) server logs to determine which IP address was given to the MAC address matching that of the switch. Other conventional ways, but no less complicated, to determine the IP address of the switch may involve performing a packet capture operation (if available) on an uplink switch to understand the DHCP exchanges.

To be clear, even using a web-based GUI to provide an initial setup mechanism may require a user to perform a special key press sequence on the switch to assign a well-known IP address to the switch. The special key press sequence is needed to acknowledge that that user has not put the switch into a production network, and the special key press sequence ensures that the switch's special IP address assignment does not happen by chance, but rather part of a conscious decision on the part of the user. Furthermore, some switch/networking vendors assign a static IP address to a switch, and require a user's computer device (through which switch setup is to be performed) to be manually configured to reside on the same subnet. Other switch/networking vendors run a small instance of a DHCP server on the switch to automate the process. Despite being automated, the process is cumbersome and so fraught with potential error scenarios, that some vendors limit the time the switch is able to operate/behave in this special mode. Moreover, many conventional setup procedures and mechanisms result in the assignment of an IPv4 address, which although still more widely used, is an outgoing addressing scheme that will eventually be replaced by IPv6. Indeed, many network devices are already capable of IPv6 addressing.

Therefore, various embodiments are directed to systems and methods of providing an IPv6 link-local address for network device setup based on that network device's Media Access Control (MAC) address. If the MAC address is known, the IPv6 link-local address can be determined using a MAC address-to-IPv6 link-local address converter that can be hosted on the web or available as an application, e.g., on a mobile device. Moreover, various embodiments leverage a simple and easy-to-follow guided workflow to reach an initial setup page via a web-based GUI.

In accordance with one embodiment, the initial setup of a switch on a network can be performed by user connecting a computing device, e.g., laptop computer, to the switch via a wired connection. The wired connection may be an Ethernet connection, and the user can be directed to a well-known URL via the switch vendor's site, for example. There, the user may enter the MAC address of the switch, launch a web-based GUI upon which the aforementioned converter is accessed/executed to convert the switch's MAC address to an IPv6 link-local address. Thereafter, the switch's web-based GUI can be loaded/launched using that IPv6 link-local address. Because of the connection between the switch and the user's computing device, there is no need for manually setting up an IP address or relying on a DHCP-based mechanism.

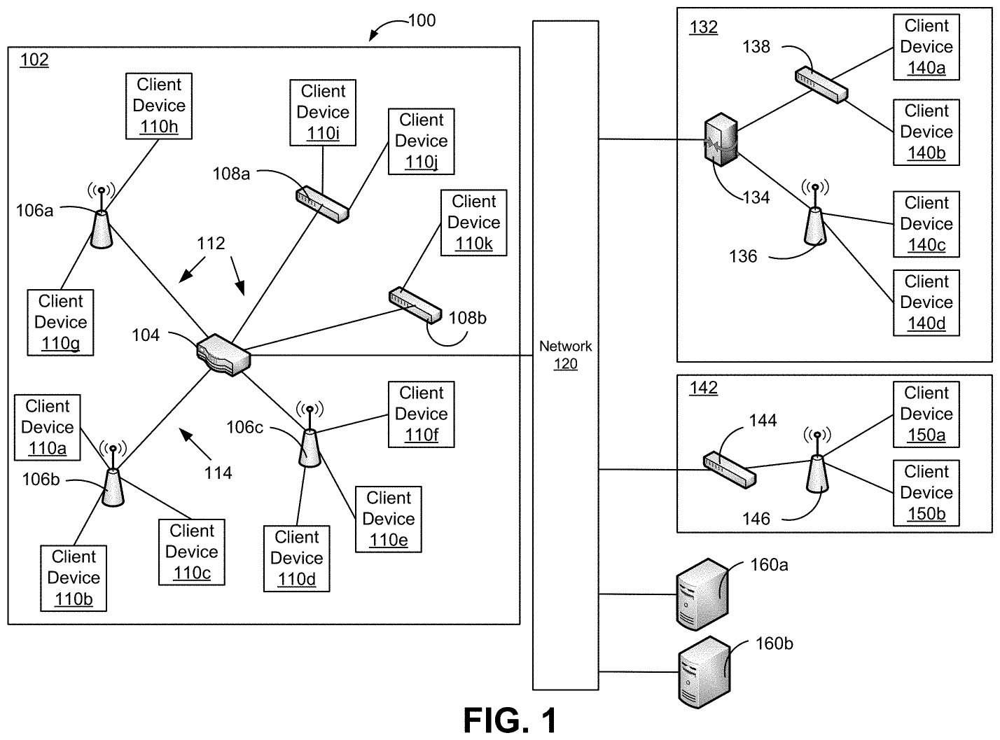

FIG. 1A illustrates one embodiment of a network configuration 100 that may be implemented for a multi-user organization, such as a business, educational institution, or any other organization or enterprise. The network configuration 100 may include a main office 102 in communication with a network 120. The network configuration 100 may also include one or more remote sites 132, 142, that are in communication with the network 120.

The main office 102 may include a primary network, which can be referred to as a corporate network or a home network. The main office 102 network may be a private network. A private network can refer to a network that may include security and access controls, such that only certain users are authorized to access the private network. Authorized users may include, for example, employees of a company based in the main office 102.

In the illustrated example, the main office 102 includes a controller 104 in communication with the network 120. The controller 104 may provide communication with the network 120 for the main office 102, though it may not be the only point of communication with the network 120 for the main office 102. A single controller 104 is illustrated, though the main office may include multiple controllers and/or multiple communication points with network 120. In some embodiments, the controller 104 communicates with the network 120 through a router (not illustrated). In other embodiments, the controller 104 provides router functionality to the devices in the main office 102.

A controller 104 may be operable to configure and manage network devices, such as at the main office 102, and may also manage network devices at the remote sites 132, 142. The controller 104 may be operable to configure and/or manage switches, routers, access points, and/or client devices connected to a network. The controller 104 may itself be, or provide the functionality of, a switch router or an access point.

The controller 104 may be in communication with one or more switches 108a-b and/or wireless APs 106a-c. Switches 108a-b and wireless APs 106a-c provide network connectivity to various client devices 110a-k. Using a connection to a switch 108a-b or AP 106a-c, a client device 110a-k is able to access network resources, including other devices on the (main office 102) network and the network 120.

Examples of client devices include, but are not limited to: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, netbook computers, televisions and similar monitors, content receivers, set-top boxes, personal digital assistants (PDAs), mobile phones, smart phones, smart terminals, dumb terminals, virtual terminals, video game consoles, and the like.

Within the main office 102, switches 108a-b are included as one example of a point of access to the network established in main office 102 for wired client devices 110i-k. Client devices 110i-k may connect to the switches 108a-b and through the switches 108a-b, may be able to access other devices within the network configuration 100. The client devices 110i-k may also be able to access the network 120, through the switches 108a-b. The client devices 110i-k may communicate with the switches 108a-b over a wired 112 connection. In the illustrated example, the switches 108a-b communicate with the controller 104 over a wired 112 connection, though this connection may also be wireless.

Wireless APs 106a-c are included as another example of a point of access to the network established in main office 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over either wired 112 or wireless 114 connections.

The network configuration 100 may include one or more remote sites 132. A remote site 132 may be located in a different physical or geographical location from the main office 102. In some cases, the remote site 132 may be in the same geographical location, or possibly the same building, as the main office 102, but lacks a direct connection to the network located within the main office 102. Instead, remote site 132 may utilize a connection over a different network, e.g., network 120. A remote site 132 such as the one illustrated in FIG. 1A may be, for example, a satellite office. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various embodiments, the remote site 132 is in direct communication with main office 102, such that client devices 140a-d at the remote site 132 access the network resources at the main office 102 as if these client devices 140a-d were located at the main office 102. In such embodiments, the remote site 132 is managed by the controller 104 at the main office 102, and the controller 104 provides the necessary connectivity, security, and accessibility that enable the remote site 132's communication with the main office 102. Once connected to the main office 102, the remote site 132 may function as a part of a private network provided by the main office 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the main office 102, such that the client devices 150a-b at remote site 142 access network resources at the main office 102 as if these client devices 150a-b were located at the main office 102. The remote site 142 may be managed by the controller 104 at the main office 102 to make this transparency possible. Once connected to the main office 102, the remote site 142 may function as a part of a private network provided by the main office 102.

The network 120 may be a public network, such as the Internet. A public network is a network that may be shared by any number of entities, including the illustrated network configuration 100. A public network may have unrestricted access, such that any user may connect to it. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a j, 140a-d, 150a-b may request and access the multimedia content provided by the content servers 160a-b.

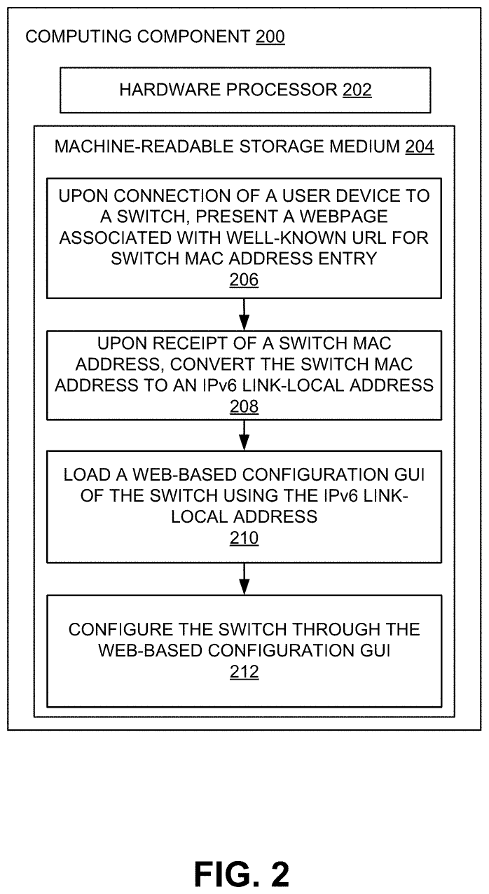

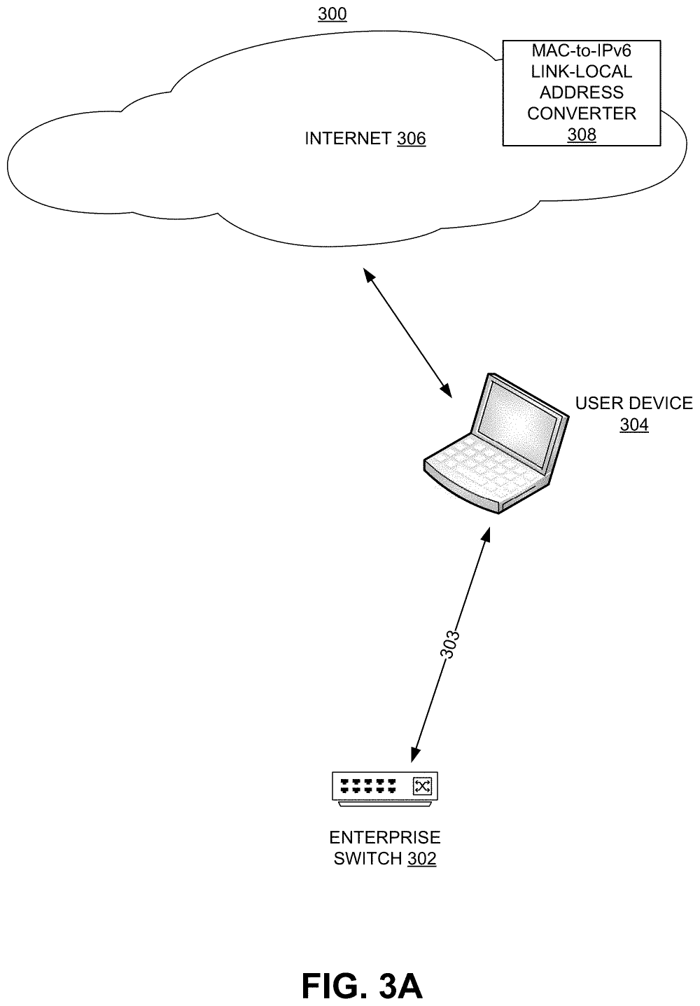

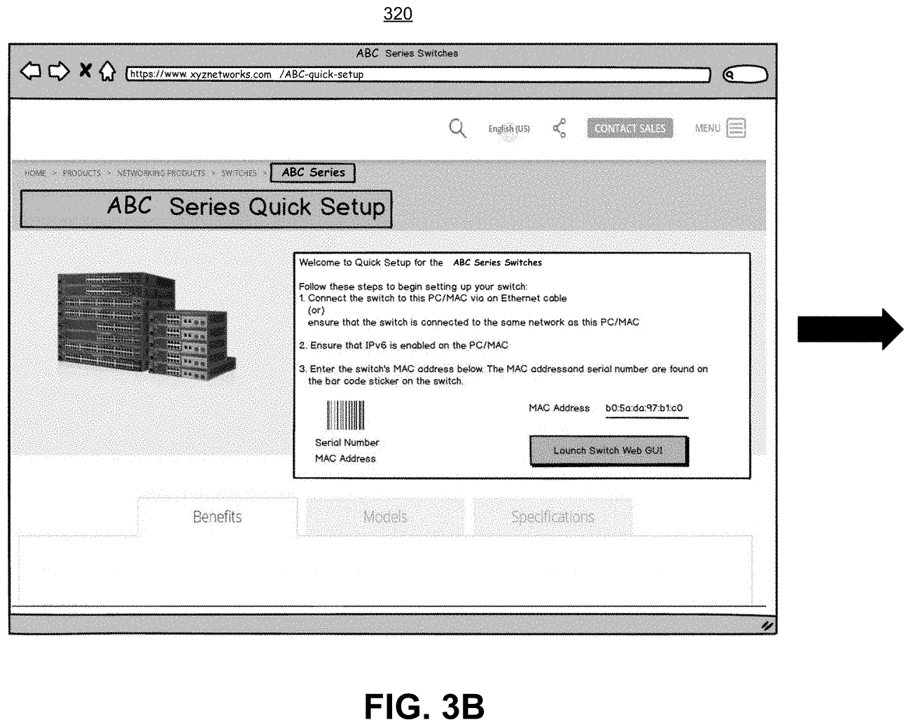

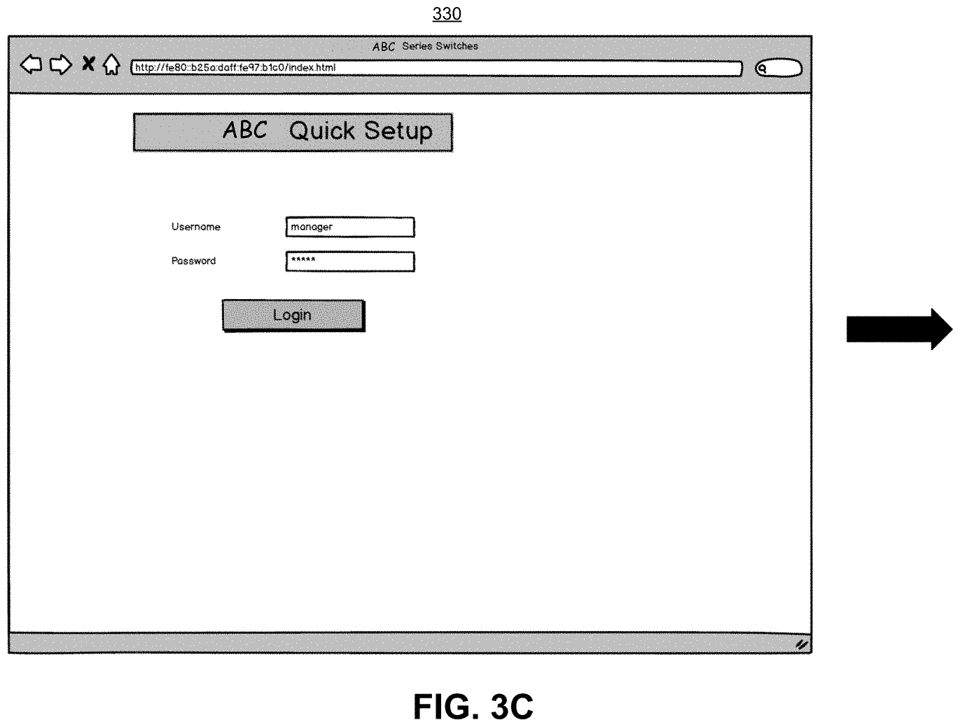

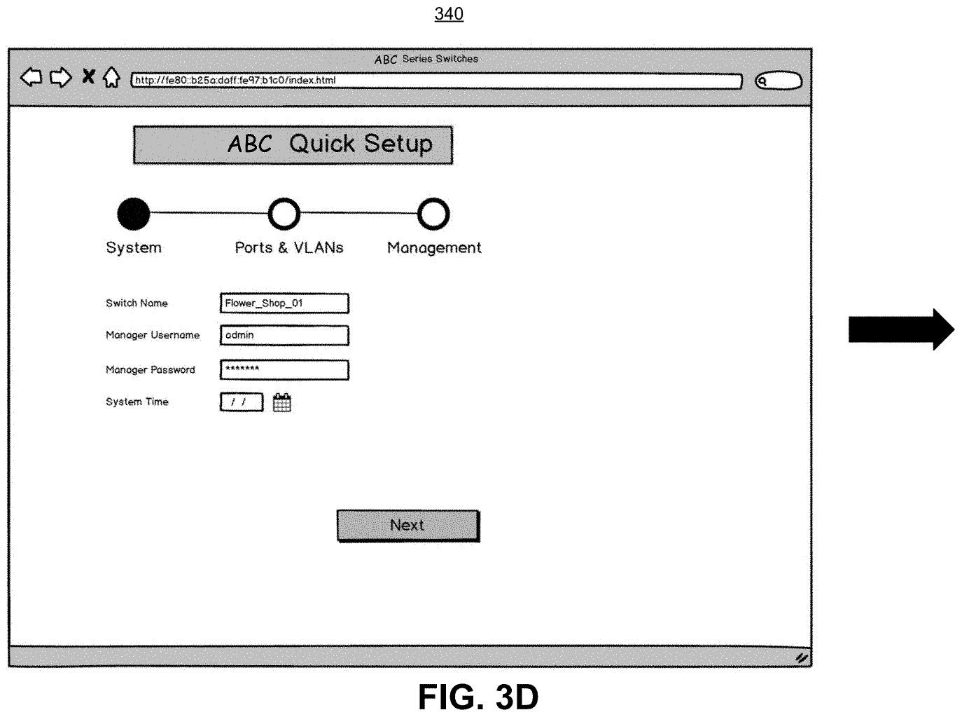

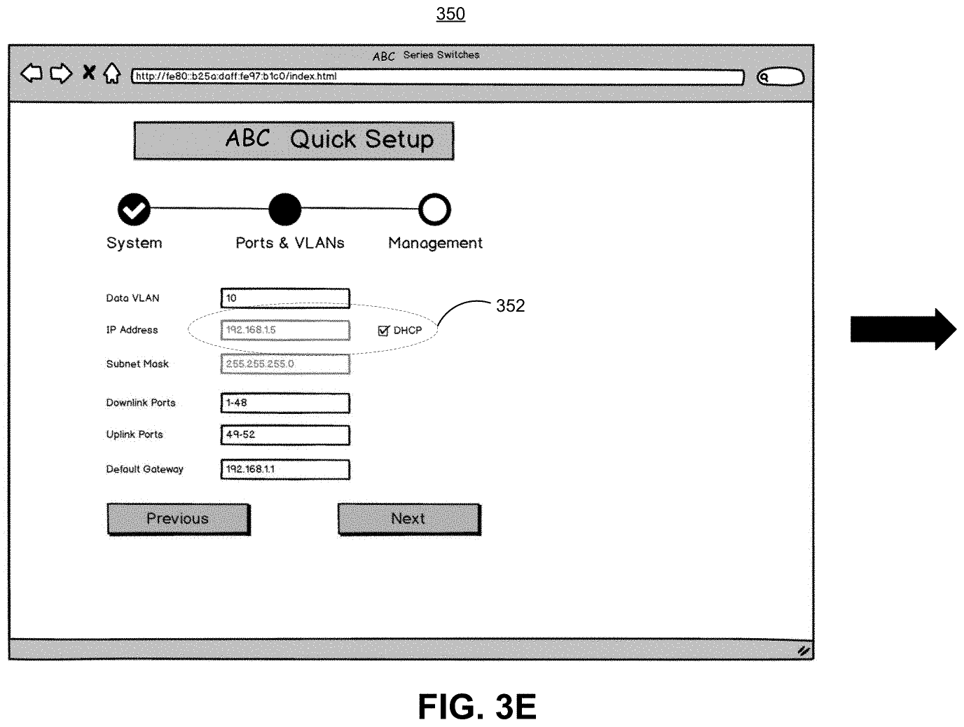

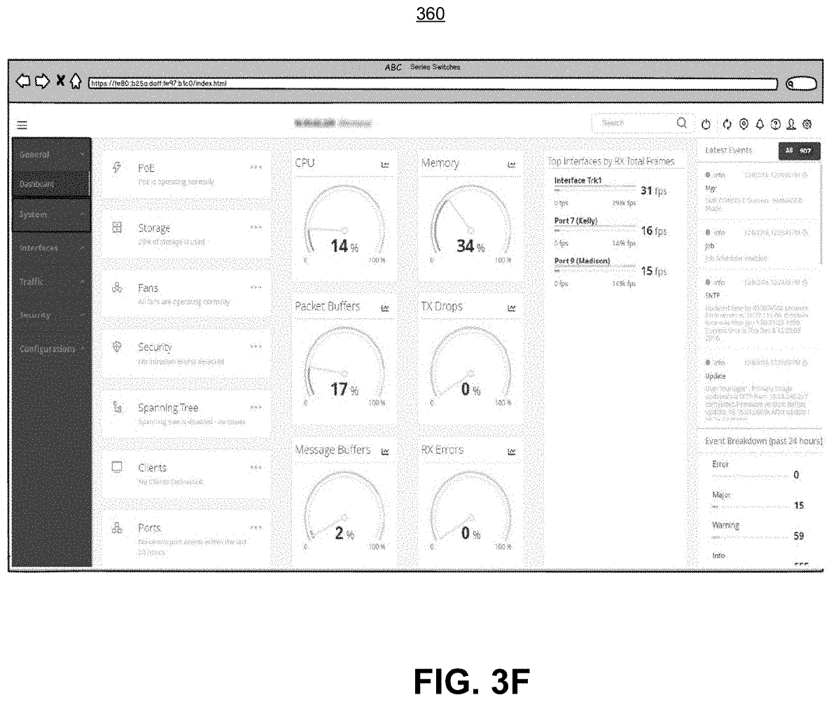

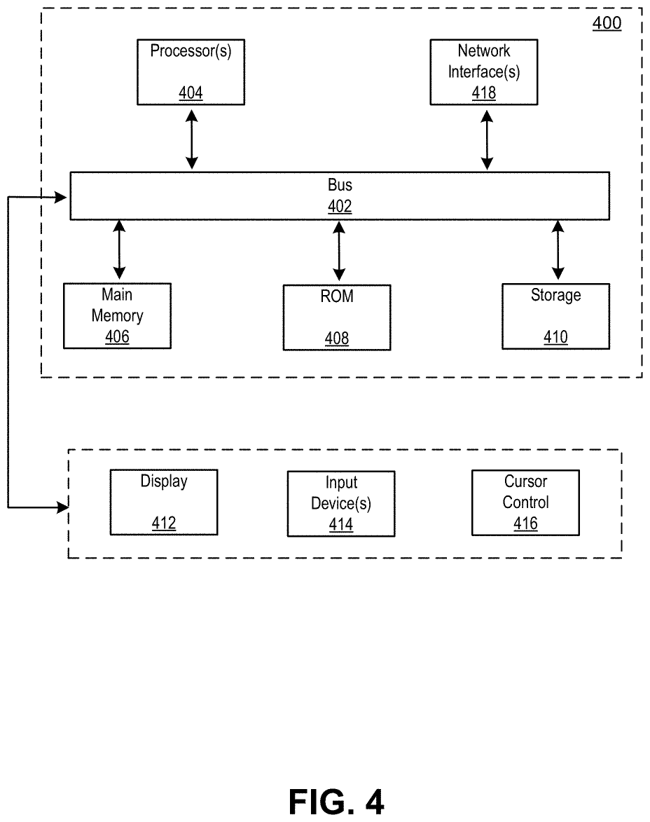

Having described an example network configuration above, particular embodiments of the disclosed technology will now be described. FIG. 2 is a block diagram of an example computing component or device 200 for performing an initial setup procedure of a network switch, e.g., switch 108a, 108b or controller 104 described above in FIG. 1. In the example implementation of FIG. 2, the computing component 200 includes a hardware processor 202, and machine-readable storage medium 204. In some embodiments, computing component 200 may be an embodiment of a user device through which the initial setup procedure may be accomplished, e.g., user device 304 (FIG. 3A), or user device 404 (FIG. 4A)

Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-212, to control processes or operations for initially setting up a network switch. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 304 may be a non-transitory storage medium, where the term “non-transitory” does not encompass transitory propagating signals. As described in detail below, machine-readable storage medium 204 may be encoded with executable instructions, for example, instructions 206-212. Depending on the implementation, the instructions may include additional, fewer, or alternative instructions, and may be performed in various orders or in parallel. Hardware processor 202 may execute instruction 206 to present a webpage associated with a well-known uniform resource locator (URL) for switch MAC address entry, in response to connection of the user device to the switch. FIG. 3A illustrates an example setup use case scenario, wherein the connection of a user device to the switch in a network 300 comprises connecting user device 304, such as a laptop computer or other computing device to the switch 302, which may be an enterprise switch (e.g., switch 108a of FIG. 1 or a controller, such as controller 104 of FIG. 1), via an Ethernet connection 303. In one embodiment, the Ethernet connection 303 may be effectuated via an Ethernet cable connected between respective Ethernet ports of the switch 302 and the user device 304. In response to connecting user device 304 to switch 302, and upon the user visiting a well-known URL, the user device 304 presents a corresponding initial setup webpage hosted on a vendor website. The vendor website may be that of the switch manufacturer, the switch distributor, or other entity through which the switch may be setup. The user of user device 304 may open a web browser on user device 304 and the web browser can bring up the webpage corresponding to the well-known URL by accessing the well-known URL via the Internet 306.

Hardware processor 202 may execute instruction 208 to convert the switch MAC address to an IPv6 link-local address upon receipt of the switch MAC address. That is, upon the web browser of user device 304 presenting the webpage associated with the well-known URL, the user may enter the MAC address of the switch 302. It should be understood that the MAC address of switch 302 is known even in the factory-default mode or state. This MAC address is generally assigned by a manufacturer of the switch, and an indicator of some type, e.g., sticker on the switch in both bar code and human readable text, is generally provided.

The webpage may present an option to launch a web-based GUI for managing the switch. Upon receipt of the switch MAC address, and the user selecting the option to launch the web-based GUI, a MAC address-to-IPv6 link-local address converter 308 is accessed via the Internet 306. In some methods of converting MAC addresses to IPv6 addresses, a router prefix is used. In a single network configuration, use of a router prefix is not problematic. However, in an enterprise network, where multiple routers can be used, use of a router prefix does become an issue. Accordingly, in some embodiments, the router prefix is ignored. The MAC address-to-IPv6 link-local address converter 308 maybe an online converter or application that can be accessed upon selecting the option to launch the web-based GUI. The MAC address (which may be a 48-bit MAC address) that was entered can be provided to the MAC address-to-IPv6 link-local address converter 308 that may then perform the conversion resulting in a 64-bit EUI-64 address.

Hardware processor 202 may execute instruction 210 to load a web-based configuration GUI of the switch using the IPv6 link-local address. That is, a web-based GUI may be launched on another tab or window of the web browser using the IPv6 link-local address, i.e., http://[IPv6_link_local_address]/index.html. In other words, a redirection occurs from the Internet 306 to an Intranet, i.e., the web-based GUI hosted on switch 302. Because user device 304 is directly connected to switch 302 (vis-à-vis Ethernet connection 303), user device 304 is able to access the web-based GUI of switch 302 without needing to set up a manual or DHCP IP address for switch 302.

Hardware processor 202 may execute instruction 212 to configure the switch through the web-based configuration GUI. Moreover, hosting the web-based GUI/webpage on the vendor's hosted website allows the vendor (or entity hosting the web-based GUI/webpage) the ability to collect valuable analytic data/information about when/where users set up their switches. Such analytics information can be based on the time and location of the user's visit to the web-based GUI/webpage and the IP address of the user device 304.

FIG. 3B is an example initial setup website or landing webpage 320 associated with the aforementioned well-known URL hosted by the switch vendor. In this example, the well-known URL corresponds to a webpage hosted by the vendor “XYZ Networks” on the domain, www.xyznetworks.com. In some embodiments, the well-known URL may correspond to a model or series of the switch to be setup, although in other embodiments, depending on the vendor, a generic setup webpage may be associated with the well-known URL. Website 320 may provide instructions for the user, e.g., enterprise administrator, to follow for performing the initial setup of switch 302. In some embodiments, as illustrated in FIG. 3B, switch 302 may not yet be connected to user device 304. Hence, the user may begin the initial setup of switch 302 by first visiting the well-known URL, wherein the user may then be instructed to connect switch 302 and user device 304 via Ethernet.

It should be understood that website 320 and its contents are merely an example, and more or less instructions, different instructions (e.g., different sequence of instructions), can be presented. The manner of MAC address entry can also vary in accordance with different, contemplated embodiments. For example, entry of the MAC address may be partially automated (e.g., automatic completion pursuant to entry of a portion of the MAC address), or may include an option for scanning or imaging of the MAC address or corresponding bar/OR code. Additionally, as described above, the initial setup website or webpage may include a web-based GUI launch button or option, the selection of which will initiate the MAC address-to-IPv6 link-local address conversion vis-à-vis MAC address-to-IPv6 link-local address converter 308.

FIG. 3C illustrates an example login webpage 330 corresponding to the web-based GUI of the switch 302 itself. It can be appreciated that the URL of the web-based GUI of switch 302 utilizes the IPv6 link-local address derived or converted from the MAC address of switch 302. In this example, the URL is “http://f380::b25a:daff:fe97:b1c0/index.html,” which is the IPv6 link-local address appended by a backward slash and a web page file name, such as, “index.html.” Again, a redirection occurs from Internet 306 back to the Intranet (web-based GUI hosted by switch 302). It can be appreciated that in accordance with various embodiments, a user is able to arrive at enterprise switch configuration based solely on a known MAC address.

FIGS. 3D and 3E illustrate example configuration webpages 340 and 350, respectively, of the web-based GUI of switch 302. A user may be presented with configuration options for switch 302 including system, port, and VLAN configurations as well as other management configuration options, but not limited to naming switch 302, entering administrator login information, syncing clock time of switch 302, etc. Further still, options regarding the configuration of downlink/uplink ports, gateway address, etc. may be presented and effectuated through the webpages 340 and 350 or web-based GUI. It should be noted that a user has the option of selecting/picking up a DHCP IPv4 address in addition to the IPv6 address already provided to/associated with switch 302.

It should be appreciated that in conventional setup mechanisms, even if some manner of web-based provisioning is used, provisioning of a DHCP-based IPv4 address results in losing connection to the switch because, as noted above, a user will not know what the new IPv4 address is. This is because conventionally, a well-known IPv4 address is used, and after the configuration to use a DHCP IPv4 address, a switch would have to pick up an IPv4 address from the network in which it is to operate. Using an IPv6 address, and selecting an option to pick up a DHCP IPv4 address (352 FIG. 3E), via the IPv6 address, switch 302 is able to access a DHCP server and pick up an IPv4 address while remaining on the web-based GUI hosted by switch 302 vis-à-vis its already assigned IPv6 link-local address. Thereafter, and in this way, a user has the option of selecting either an IPv6 or IPv4 address to use for switch 302.

FIG. 3F illustrates an example analytics and informational webpage 360 associated with switch 302, that can include but is not limited to information regarding central processing unit (CPU) usage, memory consumptions, packet/message buffering, errors such as transmission drops, reception errors, etc. Events can be monitored and/or analyzed as well. It should be understood that webpage 360 can reflect any number and/or type(s) of analytics and information, and can further be hyperlinked or directed to still other webpages or resources of interest to a user regarding the switch 302, the network 300, etc.

Various embodiments disclosed herein provides a simple and secure way for a “non-technical” or non-experienced administrator to easily locate and setup an enterprise switch. It should be understood that the guided workflow and processes disclosed herein may be used, not only for wired switches, but also for any networking device that hosts a web-based GUI for configuration. Various embodiments can be used for servers as well as storage devices that are connected to today's, modern IPv6 networks.

FIG. 4 depicts a block diagram of an example computer system 400 in which embodiments described herein may be implemented. The computer system 400 includes a bus 402 or other communication mechanism for communicating information, one or more hardware processors 404 coupled with bus 402 for processing information. Hardware processor(s) 404 may be, for example, one or more general purpose microprocessors.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a network interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or a WAN component to communicate with a WAN). Wireless links may also be implemented. In any such implementation, network interface 418 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Terms and phrases used in this document, and variations thereof, unless otherwise expressly stated, should be construed as open ended as opposed to limiting. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a hardware processor; and
a non-transitory machine-readable storage medium encoded with instructions executable by the hardware processor to perform a method comprising:
in response to connection of a user device to a switch, present a webpage associated with a well-known uniform resource locator (URL) for switch media access control (MAC) address entry;
upon receipt of a switch MAC address, converting the switch MAC address to an Internet Protocol version 6 (IPv6) link-local address;
loading a web-based configuration graphical user interface (GUI) of the switch using the IPv6 link-local address; and
configuring the switch through the web-based configuration GUI.

2. The system of claim 1, wherein the user device comprises a computer connected to the switch via a wired connection.

3. The system of claim 2, wherein the wired connection comprises an Ethernet connection.

4. The system of claim 1, wherein the conversion of the switch MAC address to the IPv6 link-local address comprises accessing an online MAC address-to-IPv6 link-local address converter to perform the conversion.

5. The system of claim 1, wherein the loading of the web-based configuration GUI occurs pursuant to an Internet-to-Intranet redirection from the URL for the switch MAC address entry to the web-based configuration GUI.

6. The system of claim 1, wherein the non-transitory machine-readable storage medium is encoded with instructions executable by the hardware processor to further perform:
providing an option to obtain a DHCP-based IPv4 address for the switch while the user device remains connected to the switch via the IPv6 link-local address.

7. The system of claim 1, wherein the non-transitory machine-readable storage medium is encoded with instructions executable by the hardware processor to further perform:
providing an analytics and informational dashboard reflecting operation of the switch while the user device is connected to the switch via the IPv6 link-local address.

8. The system of claim 1, wherein the directing of the user device to the URL for switch MAC address entry, the loading of the web-based configuration GUI of the switch, and the configuration of the switch through the web-based configuration GUI progresses in accordance with a guided workflow followed by a user of the user device.

9. The system of claim 1, wherein the conversion of the switch MAC address to the IPv6 link-local address ignores router prefixes.

10. An enterprise switch, comprising:
a hardware processor; and
a non-transitory machine-readable storage medium encoded with instructions executable by the hardware processor to perform a method comprising:
loading a web-based configuration graphical user interface (GUI) hosted on the enterprise switch, and associated with an Internet Protocol version 6 (IPv6) link-local address converted from a MAC address associated with the enterprise switch, the web-based configuration GUI allowing initial setup of the enterprise switch on a network via a user device operatively connected to the enterprise switch, the web-based configuration GUI following a guided workflow initiated in response to connection of the user device to the enterprise switch, and upon the conversion of the MAC address to the IPv6 link-local address.

11. The enterprise switch of claim 10, wherein the conversion of the MAC address to the IPv6 link local address ignores router prefixes.

12. The enterprise switch of claim 10, wherein the user device comprises a computer connected directly to the enterprise switch.

13. The enterprise switch of claim 12, wherein the direct connection comprises a wired Ethernet connection.

14. The enterprise switch of claim 10, wherein the conversion of the MAC address to the IPv6 link-local address comprises the user device accessing an online MAC address-to-IPv6 link-local address converter to perform the conversion.

15. The enterprise switch of claim 10, wherein the loading of the web-based configuration GUI occurs pursuant to an Internet-to-Intranet redirection from a well-known uniform resource locator (URL) for associated with a MAC address entry webpage to the web-based configuration GUI.

16. The enterprise switch of claim 10, wherein the non-transitory machine-readable storage medium is encoded with instructions executable by the hardware processor to further perform:
providing an option to obtain a DHCP-based IPv4 address for the switch while the user device remains connected to the switch via the IPv6 link-local address.

17. The enterprise switch of claim 1, wherein the non-transitory machine-readable storage medium is encoded with instructions executable by the hardware processor to further perform:
providing an analytics and informational dashboard reflecting operation of the switch while the user device is connected to the switch via the IPv6 link-local address.

18. The enterprise switch of claim 1, wherein the directing of the user device to the URL for switch MAC address entry, the loading of the web-based configuration GUI of the switch, and the configuration of the switch through the web-based configuration GUI progresses in accordance with a guided workflow followed by a user of the user device.

19. A system comprising:
an enterprise switch; and
a user device operatively connected to the enterprise switch, the user device adapted to:
present a webpage associated with a well-known uniform resource locator (URL) for switch media access control (MAC) address entry in response to the connection of the user device to the enterprise switch;
upon receipt of a switch MAC address, convert the switch MAC address to an Internet Protocol version 6 (IPv6) link-local address;
load a web-based configuration graphical user interface (GUI) of the switch using the IPv6 link-local address; and
configure the switch through the web-based configuration GUI.

20. The system of claim 19, whether user device is operatively connected to the enterprise switch via a wired Ethernet connection.
